(19) United States
(12) Patent Application Publication
(10) Pub. No.: US 2013/0201133 A1
(43) Pub. Date: Aug. 8, 2013

(54) METHOD AND APPARATUS FOR INPUTTING A KEY IN A PORTABLE TERMINAL

(71) Applicant: Samsung Electronics Co. Ltd., Suwon-si (KR)

(72) Inventor: Dong-Gun OH, Osan-si (KR)

(73) Assignee: Samsung Electronics Co. Ltd., Suwon-si (KR)

(21) Appl. No.: 13/758,550

(22) Filed: Feb. 4, 2013

(30) Foreign Application Priority Data
Feb. 2, 2012 (KR) 10-2012-0010891

(51) Int. Cl. G06F 3/0354

(52) U.S. Cl. CPC G06F 3/03545
USPC 345/173

(57) ABSTRACT

A method for inputting a key in a portable terminal is provided. The method includes setting a font to be used when a handwriting is converted into a text, receiving an input of the handwriting of a user by using a touch pen of a touch screen, and recognizing the input handwriting to convert the input handwriting into the text in the set font.

### PRIORITY

This application claims the benefit under 35 U.S.C. §119(a) of a Korean patent application filed on Feb. 2, 2012 in the Korean Intellectual Property Office and assigned Serial No. 10-2012-0010891, the entire disclosure of which is hereby incorporated by reference.

### BACKGROUND OF THE INVENTION

1. Field of the Invention

The present invention relates to a portable terminal. More particularly, the present invention relates to a method and an apparatus for enabling convenient use of an input handwriting when inputting the handwriting by using a touch pen in a portable terminal

2. Description of the Related Art

As a portable terminal is evolved into various forms, such as a smart phone or a tablet, the portable terminal provides various useful functions to a user, resulting in widespread use of the portable terminal

Particularly, the smart phone or the tablet is a versatile device for many applications including using multimedia and playing of a game. However, when compared to a device such as a laptop having a physical keyboard, the smart phone or the tablet is inconvenient to use for productive purposes such as document drafting.

In order to address such inconvenience, a recent portable terminal provides a touch pen of which pen input from the user is recognized through a touch screen, and the user may conveniently use the portable terminal for drafting a document or drawing a picture by using the touch pen.

However, a related-art technology for drafting the document using only the touch pen includes a technique for saving a handwriting input from the user as a drawing or a technique for converting the handwriting input from the user into a character through a character recognition function.

Particularly, in the related-art technology for converting the handwriting input from the user using the touch pen into the character, a technique for converting the input handwriting into the character in a font and a font size preferred by the user is not provided, thus creating inconvenience.

Therefore, a need exists for a technique for enabling a user to conveniently draft a document when drafting the document using a touch pen.

### SUMMARY OF THE INVENTION

Aspects of the present invention are to address at least the above-mentioned problems and/or disadvantages and to provide at least the advantages described below. Accordingly, an aspect of the present invention is to provide a method and an apparatus for allowing a user to draft a document more conveniently when drafting the document using a touch pen.

In accordance with an aspect of the present invention, a method for inputting a key in a portable terminal is provided. The method includes setting a font to be used when a handwriting is converted into a text, receiving an input of the handwriting of a user by using a touch pen of a touch screen, and recognizing the input handwriting to convert the input handwriting into the text in the set font.

In accordance with another aspect of the present invention, an apparatus for inputting a key in a portable terminal is provided. The apparatus includes a touch screen for receiving an input of a handwriting of a user by using a touch pen, and a controller for setting a font to be used when the handwriting is converted into a text and for, when the handwriting is input, recognizing the input handwriting to convert the handwriting into the text in the set font.

According to the present invention, an effect of drafting a document more conveniently through inputting a handwriting using a touch pen may be achieved.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a portable terminal according to an exemplary embodiment of the present invention;

FIG. 2 is a first flowchart illustrating a process of inputting a key using a touch pen according to an exemplary embodiment of the present invention;

FIG. 3 is a second flowchart illustrating a process of inputting a key using a touch pen according to an exemplary embodiment of the present invention;

FIGS. 4A to 4D are first example views illustrating a process of inputting a key using a touch pen according to an exemplary embodiment of the present invention;

FIGS. 5A to 5C are second example views illustrating a process of inputting a key using a touch pen according to an exemplary embodiment of the present invention; and

FIGS. 6A to 6D are third example views illustrating a process of inputting a key using a touch pen according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

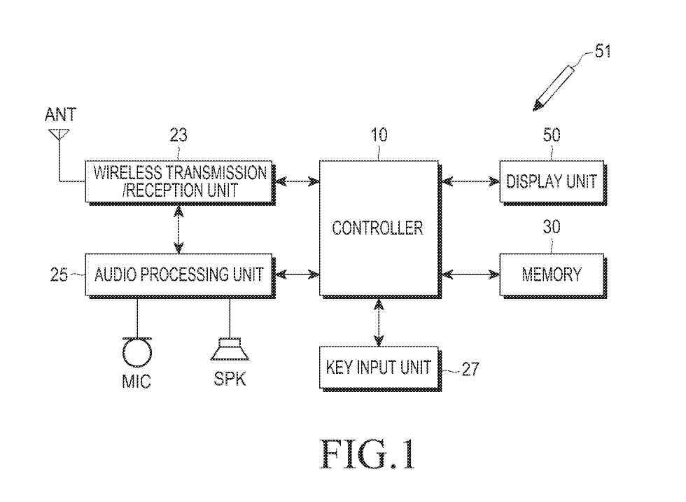

A portable terminal according to an exemplary embodiment of the present invention is an electronic device that is mobile and easy to carry and may be a video phone, a mobile phone, a smart phone, an International Mobile Telecommunication 2000 (IMT-2000) terminal, a Wideband Code Division Multiple Access (WCDMA) terminal, a Universal Mobile Telecommunication Service (UMTS) terminal, a Personal Digital Assistant (PDA), a Portable Multimedia Player (PMP), a Digital Multimedia Broadcasting (DMB) terminal, an Electronic (E)-book reader, a portable computer such as a laptop or a tablet, or a digital camera. The portable terminal according to an exemplary embodiment of the present invention will be described below with reference to FIG. 1.

A wireless transmission/reception unit 23 includes a Radio Frequency (RF) unit and a modem. The RF unit includes an RF transmitter for performing frequency up conversion and amplification of a signal to be transmitted and an RF receiver for performing low noise amplification and frequency down conversion of a received signal. The modem includes a transmitter for coding and modulating a signal to be transmitted and a receiver for decoding and demodulating a signal received from the RF unit.

An audio processing unit 25 may include a codec, and the codec may include a data codec and an audio codec. The data codec processes a packet data and the audio codec processes an audio signal such as, for example, a voice and a multimedia file. The audio processing unit 25 converts a digital audio signal received from the modem into an analog audio signal through the audio codec to be reproduced via a speaker SPK or converts an analog audio signal generated from a microphone MIC into a digital audio signal through the audio codec to be transmitted to the modem. The codec may be separately provided or included in a controller 10.

By using the audio processor 25 according to an exemplary embodiment of the present invention, the controller 10 according to an exemplary embodiment of the present invention may convert a handwriting input by a user into a text and output the converted text as sound information to the user.

A key input unit 27 may include keys used for inputting number and character information and function keys or a touch pad needed for setting various functions. When a display unit 50 is implemented in a touch screen, the key input unit 27 may include a minimum number of keys that are set beforehand and the display unit 50 may substitute a portion of a key input function of the key input unit 27.

A memory 30 may be configured as a program memory and data memories, and the program memory stores a program for controlling a general operation of the portable terminal The memory 30 may further include an external memory such as Compact Flash (CF), Secure Digital (SD), Micro Secure Digital (Micro-SD), Mini Secure Digital (mini-SD), Extreme Digital (xD), and a memory stick. Also, the memory 30 may include a disk such as Hard Disk Drive (HDD) and Solid State Disk (SSD)

The display unit 50 may be implemented using one of a Liquid Crystal Display (LCD), an Organic Light Emitting Diode (OLED) such as a Passive Matrix Organic Light Emitting Diode (PMOLED) or an Active Matrix Organic Light Emitting Diode (AMOLED), and outputs various display information generated in the portable terminal. The display unit 50 may include, for example, a capacitive, resistive, or electromagnetic touch screen and may operates as an input unit for controlling the portable terminal together with or instead of the key input unit 27.

Meanwhile, it is assumed that the display unit 50 according to an exemplary embodiment of the present invention includes a touch screen that uses both capacitive and electromagnetic technologies. Therefore, by using the display unit 50 according to an exemplary embodiment of the present invention, the controller 10 may recognize a user's input (for example, handwriting) through a touch pen 51 corresponding to the electromagnetic touch screen and, at about the same time, may recognize whether an input user's handwriting is bold or thin depending on handwriting pressure (e.g., strong or weak pressure).

Here, although the handwriting may be input by using a part of the user's body (for example, a finger), it is assumed in an exemplary embodiment of the present invention that the handwriting is input by using the touch pen 51.

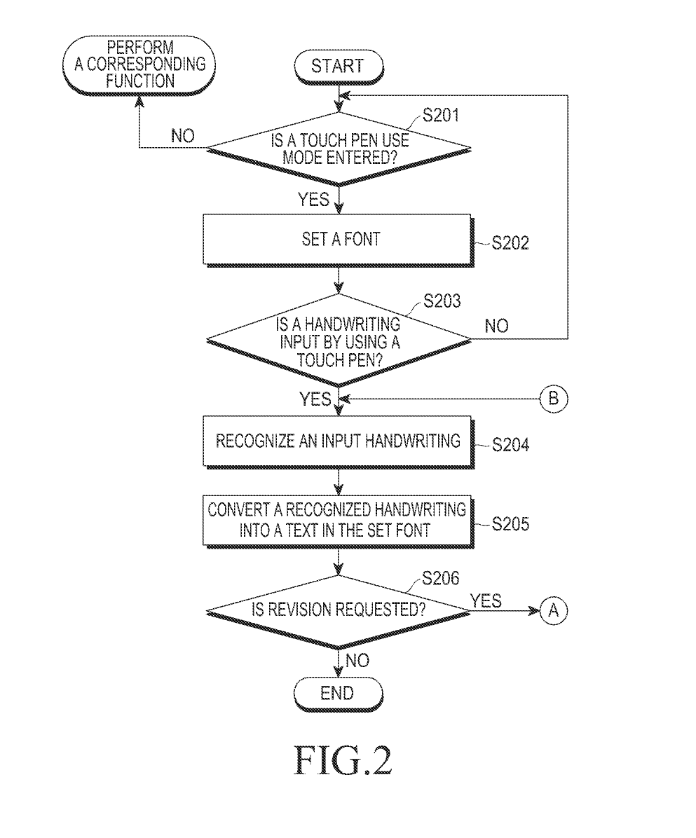

The controller 10 controls an overall operation of the portable terminal according to an exemplary embodiment of the present invention and may convert and control an operation of the portable terminal according to a user input that is input through the key input unit 27 or the display unit 50. Meanwhile, in a key input method of the portable terminal, the controller 10 according to an exemplary embodiment of the present invention receives setting of a font to be used when converting the handwriting into the text, receives the user's handwriting input using the touch pen of the touch screen, and recognizes and converts the input handwriting into the text in the set font. A detailed operation of the controller 10 according to an exemplary embodiment of the present invention will be described below with reference to FIG. 2.

Meanwhile, devices such as a Bluetooth module, a camera module, a Wi-Fi module, an accelerometer sensor, a proximity sensor, an electromagnetic field sensor, and a Digital Media Broadcasting (DMB) receiver which can be included in the portable terminal are not shown in the block diagram of FIG. 1, however, it should be appreciated by a person of ordinary skill in the art that the devices that are not shown may be included in the portable terminal according to an exemplary embodiment of the present invention to provide a corresponding function.

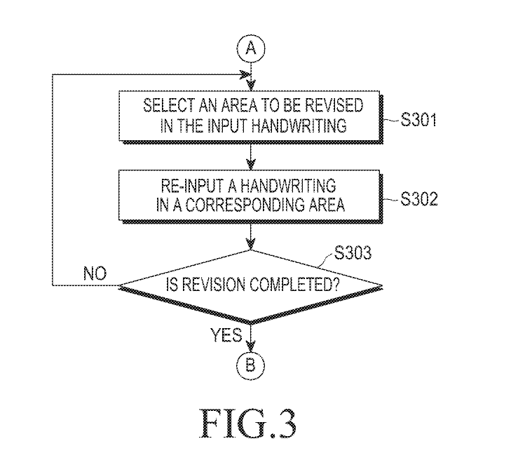

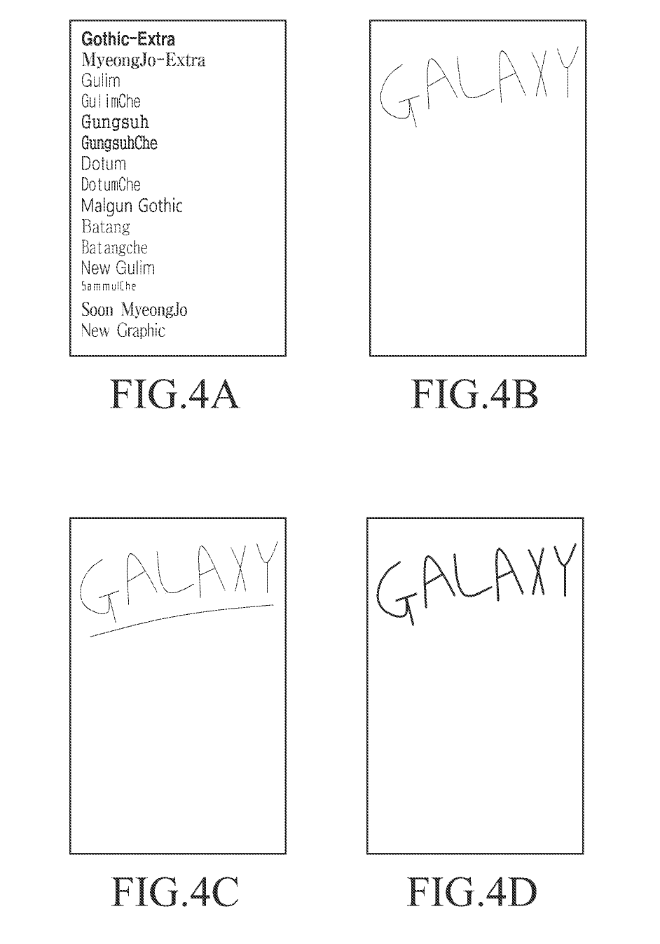

FIG. 2 is a first flowchart illustrating a process of inputting a key using a touch pen according to an exemplary embodiment of the present invention and FIG. 3 is a second flowchart illustrating a process of inputting a key using a touch pen according to an exemplary embodiment of the present invention. Also, FIGS. 4A through 6D are respectively a first example view, a second example view, and a third example view illustrating a process of inputting a key using a touch pen according to an exemplary embodiment of the present invention. Hereinafter, exemplary embodiments of the present invention are described with reference to the flowcharts and example views.

In step S201, the controller 10 determines whether a touch pen mode is entered. Here, the request for entering into the touch pen use mode may be made according to a request by the user for entering into the touch pen use mode. The user may request to enter into the touch pen use mode through, for example, selecting a corresponding menu or executing a corresponding application in order to enter the user's handwriting using the touch pen. If the touch pen use mode is not entered in step S201, a corresponding function is performed.

Otherwise, in step S202, if the touch pen use mode is entered, the controller 10 controls to receive font setting from the user. The user may set (or select) a font among various fonts shown in FIG. 4A to be used when the user's handwriting is recognized and converted into text.

Meanwhile, the present invention is not limited to the number of fonts shown in FIG. 4A and the user may select a different type of a font that is not shown in FIG. 4A.

In step S203, the controller 10 determines whether handwriting is input using a touch pen. If it is determined that handwriting not being input using the touch pen, the process returns to step S210. Otherwise, in step S204, the controller 10 receives the user's handwriting entered by using the touch pen of the touch screen and recognizes the input handwriting. In step S205, the controller 10 controls to convert the input handwriting into text in the set font.

In an exemplary embodiment of the present invention, the user may enter the handwriting in one of the forms shown in FIG. 4B through FIG. 4D or may enter the handwriting in which three forms are combined.

FIG. 4B illustrates an example in which the user generally inputs a handwriting by using the touch pen, FIG. 4C illustrates an example in which the user inputs underlining together with the handwriting in FIG. 4B, and FIG. 4D illustrates an example in which the user inputs a handwriting in bold compared with the handwriting in FIG. 4B. Also, although not shown in the drawings, the user may input a handwriting in bold compared with the handwriting in FIG. 4B while at the same time inputting the underlining together with the handwriting (i.e., a combination of FIG. 4C and FIG. 4D).

As described above, when the handwriting is input from the user, the controller 10 recognizes the handwriting input from the user and controls to convert the recognized handwriting into the text in the font set in step S202, i.e., selected by the user.

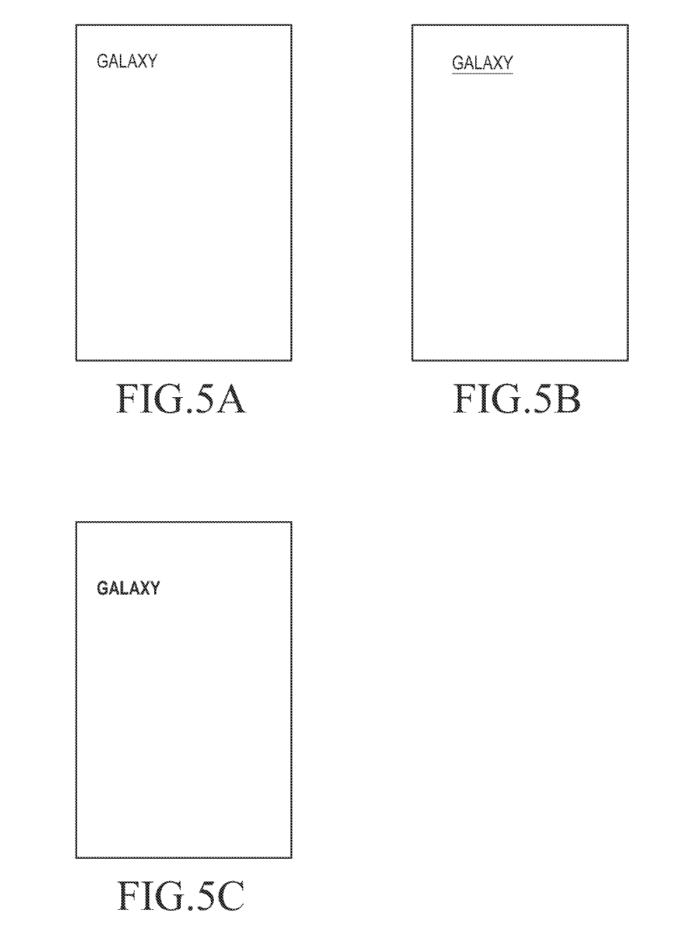

For example, when the handwriting in FIG. 4B is recognized, the controller 10 controls to convert the handwriting into the text shown in FIG. 5A. When the handwriting in FIG. 4C is recognized, the controller 10 controls to convert the handwriting into the text shown in FIG. 5B. Moreover, when the handwriting in FIG. 4D is recognized, the controller 10 controls to convert the handwriting into the text shown in FIG. 5C.

Here, FIG. 5A illustrates an example in which the font selected by the user is Gothic-Extra, FIG. 5B illustrates an example in which the font selected by the user is Gulim, and FIG. 5C illustrates an example in which the font selected by the user is Malgun-Gothic.

Also, FIG. 5B illustrates an example in which a handwriting with underlining is converted into a text in the font of Gulim with underlining, and FIG. 5C illustrates an example in which a handwriting in bold is converted in a text in the font of Malgun-Gothic in bold.

Also, although not shown in the drawings, when the handwriting input from the user is recognized as being tilted at a predetermined (predefined) angle or more with respect to a vertical line, for example, 45 degrees, the handwriting may be converted into an italicized text. For example, when the font selected by the user is Gulim and the input handwriting is tilted at 45 degrees, the controller 10 controls to convert the input handwriting in an italicized Gulim font.

Meanwhile, in an exemplary embodiment of the present invention, the controller 10 may control to display the input handwriting together with the converted text (e.g., display a conversion process while converting the input handwriting in real-time), and in this manner, the user may easily identify the conversion of the input handwriting into the text. For example, the controller 10 may display FIG. 4B together with FIG. 5A corresponding thereto, or display FIG. 4C together with FIG. 5B corresponding thereto, or display FIG. 4D together with FIG. 5C corresponding thereto.

Also, a time point at which the controller 10 converts the handwriting input from the user into the text may substantially correspond to a time point at which an input (e.g., a double tapping input) indicating that an input of the user's handwriting is completed or a time point at which the input handwriting is recognized when the handwriting is input from the user.

In step S206, when revision of the converted text is requested from the user, the controller 10 controls to proceed to the process described below with reference to FIG. 3.

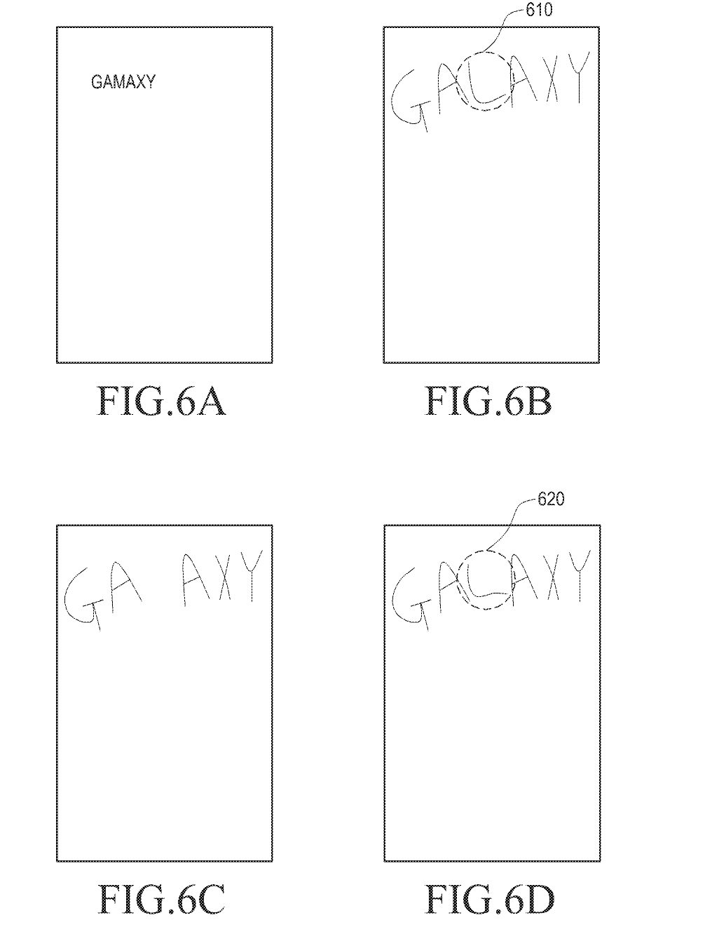

Referring to FIG. 6A, when it is determined that the text (e.g. “GAMAXY”) into which the user's handwriting is converted by the controller 10 is not the text (e.g., “GALAXY”) intended by the user, the user may revise the converted text, which will be described with reference to FIG. 3.

In step S301, the user selects an area to be revised in the handwriting previously input. In step S302, the user re-inputs the handwriting. In step S303, if the revision is complete the controller 10 proceeds to step S204 to re-convert the handwriting into corresponding text. Here, if the revision is not complete, the process returns to step S301.

In steps S301-S303, when the handwriting input by the user is displayed as FIG. 6B according to a revision request, the user selects an area 610 to be revised from the handwriting previously input, deletes the selected area as shown in FIG. 6C, and re-inputs a corrected part 620 (e.g., “L”) as shown in FIG. 6D. Next, the controller 10 controls to re-convert the revised handwriting into the text in the set font, similar to the method described with reference to FIG. 2.

According to the exemplary embodiments of the present invention described above, the user may be provided with advantages such that the user may draft a document more conveniently through inputting a handwriting using a touch pen.

While the present invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. A method for inputting a key in a portable terminal, the method comprising:
setting a font to be used when a handwriting is converted into a text;
receiving an input of the handwriting of a user by using a touch pen of a touch screen; and
recognizing the input handwriting to convert the input handwriting into the text in the set font.

2. The method of claim 1, wherein the setting of the font to be used when the handwriting is converted into the text comprises:
receiving the font setting from the user.

3. The method of claim 1, further comprising:
displaying the input handwriting with the converted text.

4. The method of claim 1, further comprising:
receiving a request to revise the converted text in the set font.

5. The method of claim 4, further comprising:
when an area to be revised is selected from the input handwriting, re-receiving a handwriting corresponding to the selected area and revising the input handwriting; and
re-converting the revised handwriting into the text in the set font.

6. The method of claim 1, wherein the converting of the input handwriting into the text comprises:
converting the input handwriting into the text in the set font underlined when the recognized handwriting is recognized as being underlined.

7. The method of claim 1, wherein the converting of the input handwriting into the text comprises:
setting the font as the font in bold and converting the handwriting into the set font in bold when the recognized handwriting is recognized as being input in a predetermined thickness.

8. The method of claim 1, wherein the converting of the input handwriting into the text comprises:
setting the font as the font italicized and converting the handwriting into the set font italicized when the recognized handwriting is recognized as being tilted at a predetermined angle or more with respect to a vertical direction.

9. An apparatus for inputting a key in a portable terminal, the apparatus comprising:
a touch screen for receiving an input of a handwriting of a user by using a touch pen; and
a controller for setting a font to be used when the handwriting is converted into a text and for, when the handwriting is input, recognizing the input handwriting to convert the handwriting into the text in the set font.

10. The apparatus of claim 9, wherein the controller receives the setting of the font from the user.

11. The apparatus of claim 9, wherein the controller controls to display the input handwriting with the converted text.

12. The apparatus of claim 9, wherein the controller receives from the user a request to revise the converted text in the set font.

13. The apparatus of claim 12, wherein, when an area to be revised is selected from the input handwriting, a handwriting corresponding to the selected area is re-input, and the input handwriting is revised, the controller re-converts the revised handwriting into the text in the set font.

14. The apparatus of claim 9, wherein, when the recognized handwriting is recognized as being underlined, the controller controls to convert the input handwriting into the text in the set font underlined.

15. The apparatus of claim 9, wherein, when the recognized handwriting is recognized as being input in a predetermined thickness, the controller controls to set the font as the font in bold and converts the handwriting into the set font in bold.

16. The apparatus of claim 9, wherein, when the recognized handwriting is recognized as being tilted at a predetermined angle or more with respect to a vertical direction, the controller sets the font as the font italicized and converts the handwriting into the set font italicized.
